(19) United States
(12) Patent Application Publication
(10) Pub. No.: US 2009/0192787 A1
(43) Pub. Date: Jul. 30, 2009

(54) GRAMMER CHECKER

(75) Inventor: Adam Roon, Karme Yosef (IL)

Correspondence Address: DEBORAH A. GADOR, P.O. BOX 4133, GANEL TIKVA, 55900, IL

(73) Assignees: DAVID BLUM, GIVATAYIM (IL); DEBORAH GADOR, GIVATAYIM (IL)

(21) Appl. No.: 12/246,510

(22) Filed: Oct. 7, 2008

(30) Foreign Application Priority Data
Oct. 8, 2007 (IL) 186505

(51) Int. Cl. G06F 17/27; G06F 17/21; G06F 17/24

(52) U.S. Cl. 704/9; 715/256

(57) ABSTRACT

A method for parsing a computerized text, the method including preparing a set of logical rules, using logical grammatical links, for parsing a text, using the logical rules to identify a part of speech of each word of text and all links between the words in the text, and labeling the links as grammatically correct links or grammatically incorrect links for correction, so as to parse substantially every word in the text.

### FIELD OF THE INVENTION

The present invention relates to a system and method for automatic grammar checking of computerized textual documents.

### BACKGROUND OF THE INVENTION

Automatic grammar correction software was created in order to help users improve the quality of their text by identifying errors and then proposing a correct alternative. The earliest “grammar checkers” were really programs that checked for punctuation and style problems, rather than finding many actual grammatical errors. These programs started out as simple diction and style checkers and, eventually, various levels of language processing were added and the programs developed some level of true grammar checking capability.

One impediment to efficient grammar checking was the belief that, as the computer cannot get into the writer's head to discern his or her meaning, complete grammar correction is impossible.

Automatic or computerized grammar checkers must proceed in two steps:

1. Text parsing;

2. Error identification and correction of the parsed text.

Text parsing attributes a part of speech to each word in a text to be checked, and determines which phrase each word belongs to in the various clauses or what the links between the words are. This information is necessary for decision-making in the error-correction portion of the program, for determining if an error has been found and what the appropriate corrections are. After the parser has parsed a text, the grammar checker can process its output in order to correct the sentence, if there are any errors in it.

There are two conventional approaches to text parsing:

1. Statistical corpus-based parsing (The lexical approach).

2. Logical parsing (the logical approach).

Many parsers are a mix of both statistical and logical parsing. Most grammar checkers use corpus-based parsers because these parsers are faster and they always provide an answer.

In the lexical approach, the system uses a statistical parser to determine what part of speech each word in the sentence represents, and then looks for rules to check if the sentence is correct. Thus, the parser selects the part of speech of each word based on the highest likelihood. Typically, it compares the selected text to various examples from a large database of correct grammatical patterns and uses the best match to select, statistically, the pattern which is most likely to be correct or incorrect.

The main problem with this approach is that the whole system must rely on the definitions and rules that govern the database of the parser in identifying sentence structures and parts of speech. These conventional software products allow no deviation from their sets of rules, which renders them rather rigid. Furthermore, the statistical approach is problematic because grammar must and should be logical. The rules in grammar must be logical because otherwise people would not be able to apply them. Unfortunately, classical grammar does not offer the luxury of such mathematical logic. On the other hand, there are many “grammatically correct” projects in formal languages (i.e., computer languages), because their logic is well known.

One logical parser has been developed, Link Grammar, manufactured by Davy Temperley, Daniel Sleator and John Lafferty from Carnegie Mellon University, Pittsburgh Pa., USA. Link Grammar assigns a syntactic structure to a given sentence, which consists of a set of labeled links connecting pairs of words. The parser also produces a “constituent” representation of a sentence (showing noun phrases, verb phrases, etc.). Thus, it identifies words and phrases and attributes a letter to each particular function (subject, direct or indirect object, time indicator, etc.) and then a set of letters to each type of link (subject/verb, Verb ONE/Verb TWO, verb of state/adjective, etc.). More detail can be found at http://www.link.cs.cmu.edu/link/.

Link Grammar allows one to replace and modify rules very quickly, parse and find errors, and find only correct structures, and consequently point out still uncorrected errors. Link Grammar recognizes possible links between individual words. Consequently, if a word is not in the right form, Link Grammar will probably not recognize it and, even should it recognize the modified word, it will not know what to do with it (because no link to the malformed or missing word exists). It is also comparatively slow. In addition, it is hard for it to identify the nature of errors and, therefore, propose a correction.

The known grammar checkers based on the statistical approach suffer from a lack of accuracy and lack of error coverage. First, this means that many errors aren't discovered because the program cannot identify them. For example, the grammar checker built into Microsoft Word 2007 has no problem correcting the sentence: “He are crazy?” to “He is crazy”, but it doesn't see a problem when it comes to the sentence: “Why does you coming home.”. Although both errors are of the same kind, namely very simple subject/verb mismatches, in the former case, the program can “see” the problem, and in the latter it cannot. There are also situations where the grammar checker believes it has found an error in an absolutely correct sentence. This can prove very problematic for a user who cannot distinguish between a real error and an unnecessary correction. This problem resides in the whole approach of these programs and occurs with most conventional grammar checkers.

In addition, there is the lack of error coverage. This means that a large number of errors are not checked at all by the grammar correction portion of the program or are covered very partially. Here a few examples:
Ambiguous pronouns. When a pronoun is used but it is not clear to what or whom it refers. Example: “I saw my mother and my sister and she looked beautiful” (It is not clear if “she” refers to “my mother” or to “my sister”)
Tense errors.
   “She has finishing her meal”
Time errors.
   I told my students that they need to work harder.
   Correct version: I told my students that they needed to work harder.
Wrongly placed noun phrases
   We met at school all the parents.
      Correct version: We met all the parents at school.
Wrong or missing preposition
   We believe at God.
      Correct version: We believe in God.
   He came to town a car.
      Correct version: He came to town in a car.

The main problem for grammar checkers today is that they consider these kinds of errors as strongly dependent on context and semantics, and consequently believe that, in order to offer corrections, the program needs to be able “to read the user's mind”. As reading the user's mind does not represent a practical option, the whole idea of correcting grammar has been shelved. This has brought about a situation in which grammar checkers not only fail to assure users that their text is correct, but often enough change correct sentences into incorrect ones.

There is, therefore, a long-felt need for a grammar checker utilizing more accurate parsing, and it would be desirable if it identified more errors and provided correct alternatives while not correcting already correct text.

### SUMMARY OF THE INVENTION

The present invention provides a method and system for improving the way grammar-checking software looks at sentences and for increasing the quality and number of error corrections. This is accomplished by using a logical approach instead of the statistical approach, i.e., utilizing a logical parser capable of accurately parsing most texts, and an error-detection engine (EDE) including grammar-correction software utilizing a set of absolute grammatical rules, which cover substantially all possible text links and which do not allow for any exceptions, so as to permit correction of every grammatical error in a sentence. The invention is based on the principle that language is basically a set of constraints. In addition, it has been found that basic language structure is common to all Western, Indo-Iranian languages (practically all languages west of India).

The present invention relates to a method for computerized grammar checking (parsing, error-detection and correction of text). The method involves logical parsing of the text so as to identify more accurately the various parts of speech in the text. Preferably, a link parser is provided, which identifies parts of speech via relationships between words in the text. Most preferably, parsing takes place after the text has been corrected by a spell checker, so as to reduce the likelihood of incorrectly spelled words entering the parser. A hierarchical set of grammatical rules is defined, setting out the logical relationship of words (parts of speech) in phrases and sentences in the relevant language. It is a particular feature of this set of logical grammatical rules (technical constraints) that they always provide grammatically correct connections between words in the text, and have substantially no exceptions. These grammatical rules are applied to the parts of speech identified by the parser, to determine if there is an erroneous coupling between parts of speech (words in a phrase) or between various parts of a sentence in the text, as written. If there are one or more erroneous connections, i.e., a grammatical rule that is not met, suggestions are provided for rearranging and/or replacing certain words so as to fulfill the grammatical rule which was not met. After one correction has been made, the sentence or phrase is re-parsed to determine whether additional errors exist in the corrected sentence.

There is also provided according to the present invention a method for computerized grammar checking of text, the method including logical parsing of the text to assign logically parts of speech to each word of text and define links between words, and applying a set of logical grammatical rules, in a pre-defined order, to the parsed text to identify erroneous combinations, and correcting only those erroneous combinations.

The process includes the following steps, carried out in the following order: sentence cleaning; null-words error; form error (link grammar) detection; and structure/complex error correction. Optionally, false-positive analysis may be implemented.

There is thus provided, in accordance with the present invention, a method for parsing a computerized text, the method including preparing a set of logical rules, using logical grammatical links, for parsing a text; using the logical rules to identify a part of speech of each word of text and all links between the words in the text; and labeling the links as grammatically correct links or grammatically incorrect links for correction, so as to parse substantially every word in the text.

There is also provided, according to the invention, a method for grammar checking of a computerized text, the method including preparing a collection of absolute grammatical rules defining substantially all possible text links; applying the grammatical rules to parsed text for identifying grammatical errors in the text; and providing at least one suggested correction which is grammatically correct according to the rules.

Further according to the invention, there is provided a logical parser including a set of logical rules, using logical grammatical links, for parsing a text; the logical rules including rules for identifying a part of speech of each word of text and all links between the words in the text, and labeling the links as grammatically correct links or grammatically incorrect links for correction, to parse completely the text.

There is also provided, according to the invention, a system for checking grammar of a computerized text, the system including a logical error identification module including a collection of absolute grammatical rules defining substantially all possible text links; and an error-detection engine for applying the grammatical rules to parsed text for identifying grammatical errors and providing at least one suggested correction which is grammatically correct according to the rules.

### BRIEF DESCRIPTION OF THE DRAWINGS

The present invention will be further understood and appreciated from the following detailed description taken in conjunction with the drawings in which:

FIG. 1 is a flow chart of a method of checking grammar, according to one embodiment of the present invention;

FIG. 2 is a flow chart of a process of grammar checking and error correction according to one embodiment of the present invention; and

FIG. 3 is a textual example of the grammar checking process of a phrase of text, according to one embodiment of the invention.

### DETAILED DESCRIPTION OF THE INVENTION

The present invention relates to a method and system for computerized grammar checking (sentence parsing, error detection and correction of text). Substantially all the elements required to know which decision to make according to the elements in the sentence, or in a specific phrase environment, are provided to the grammar checker.

Each part of the program is intimately related to and dependent on language management definitions and rules, which set forth the logically correct structural relationships between words in a sentence according to the rules. These language management rules are a set of rules by which text in the selected language can be parsed and corrected, according to a preferred embodiment of the present invention. The organization of language into phrases, and the rules followed by these phrases, are set forth in Appendix I. Each rule or definition can be considered as a pattern leading to the identification of either a correct phrase (a correct set combination of words) or an erroneous one.

Before beginning the grammar checking, a conventional spell checker is utilized to avoid entering an incorrectly spelled word into the system, which might corrupt the results. Spell checkers use pattern matching and are well known in the art.

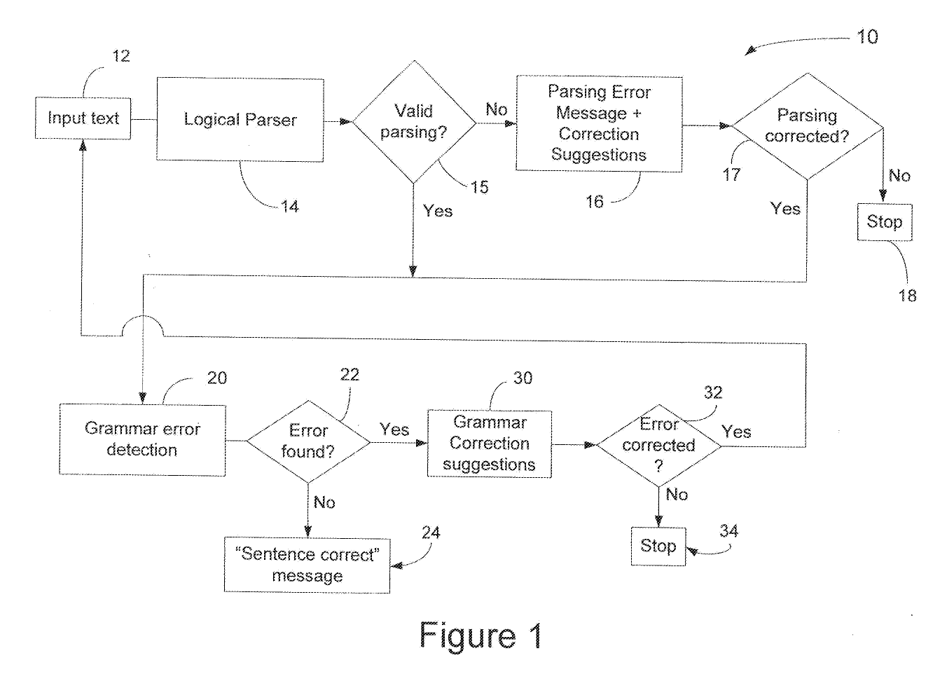

FIG. 1 is a flow chart of a method of checking grammar, according to one embodiment of the present invention. In order to be able to correct a sentence, one must:
1. Parse the sentence, so as to identify the sentence structure and the part of speech each word represents (block 14).
2. If the parsing result identifies any parsing errors, an error message is sent (block 16) and suggestions are provided for cleaning the sentence. If no correction is made, grammar checking is stopped (block 18).
3. Once all the words have been parsed (block 15 or 17), apply language management rules to the sentence in order to see if there is any structure which is not viable in the sentence (block 20).
4. Once an error has been found, propose correct alternatives to this specific error (block 30).
5. When a correction alternative has been selected, begin again by parsing the corrected sentence (block 14).

The first, and most important, step is parsing the text using a logical parser. Each sentence in an input text (block 12) to be checked must be parsed by a parser (block 14), preferably by a logical parser, capable of parsing every word in the text, before it is sent to the grammar correction module 20. According to one embodiment of the invention, the conventional logical parser Link Grammar (described above) is modified to make it suitable for the present invention. Additional links are defined and added to the prior dictionary of links in the logical parser. A selected letter is applied to various links that the original software had hitherto failed to recognize but, instead, produced a <null word> verdict. These links are called “error links”, and they simply indicate there is an error involved. One exemplary technique for creating these links is as follows: the same name as the correct link is attributed to them, but a letter, preferably the letter <L> (the only letter not used by Link Grammar), is added to distinguish it from the correct link. This way, the parser relates to the link as if it were a proper link. For example, in the original version of the dictionary of Link Grammar, the sentence <He are alone> has no valid parsing results because <are> cannot be linked to <He>. According to the present invention, a link is added to the dictionary of links of the logical parser that allows a singular subject and a plural verb to be linked (but marked as an error link), thereby permitting parsing of the words in the grammatically incorrect link. Then, when the grammar error detection program checks the output of the parser, it simply looks for the marked links and proceeds to correct the sentence according to its own grammatical rules, as described below.

As Link Grammar denotes <Null words>, a term that does not identify the error, it is desirable to reduce, as much as possible, the number of cases of <Null Words> error. In the novel logical parser, the added letter does not provoke the “Null word” message, but rather points to the nature of the error. Additionally, the parser relates to the sentence as if these errors have already been corrected. The new error link is given a higher cost (larger code of acceptability) than the correct link. Thus, the parser will favor the correct links over the incorrect links.

As described below in detail, if some words are unable to be parsed (block 15), an error message is output (block 16) and the error is corrected, if possible. For example, if the parsing result contains unused (non-parsable) words (null words), an error message is sent (block 16) together with suggestions for cleaning the sentence by verifying that there aren't any homonym errors or missing/misplaced vocabulary (typically missing prepositions or determiners). If no correction is made, the grammar checking stops (block 18).

Once all the text is parsed, the output goes to the error detection engine (EDE) in a grammar correction module 20. The EDE includes a set of logical grammatical rules for identification of linkage errors and structural errors in the sentence, as well as a correction options generator for providing suggested corrections which comply with the grammatical rules. If no errors are found, a “sentence correct” message is displayed (block 24). For each error that the EDE finds (block 22), it creates an error object. The error object contains:

1. The definition of the error.

2. The significant words (usually the words that cause the problem).

3. A list 30 of corrections.

An example of error objects is as follows:

a. He are swims.
i. verb/subject error (He are)

1. One option:

a. <He is>
ii. verb ONE verb TWO error (are swims).

1. two options:

a. are swimming

b. swims

When a correction suggestion has been accepted (block 32) by the user, the corrected text is input (block 12) to the parser to start the process all over again. If the user decides not to correct the errors, the grammar checking stops (block 34).

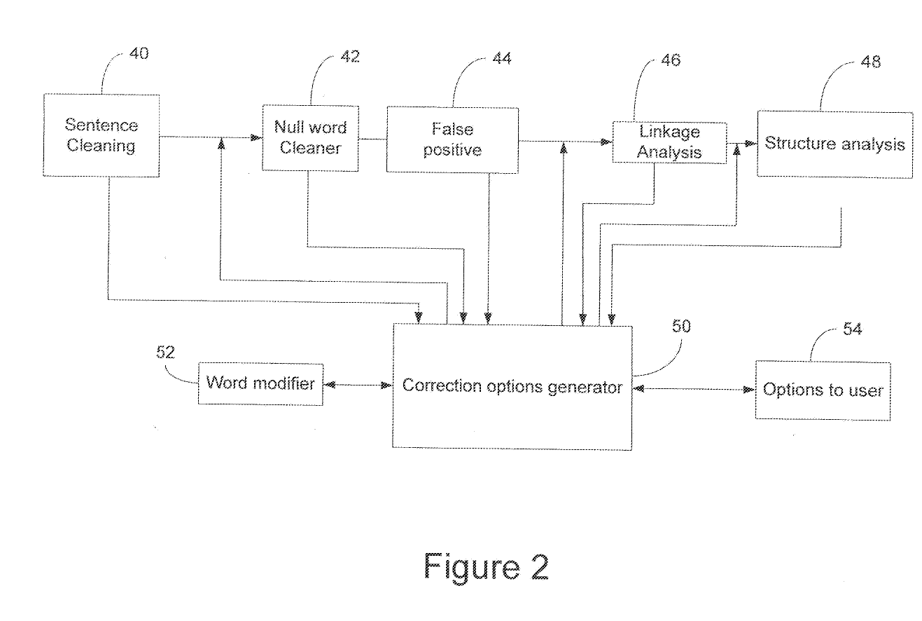

FIG. 2 is a flow chart of the process of error detection (identification) and correction (applying logical grammatical rules) of a sentence of text, according to a preferred embodiment of the invention. There are several operations or modules in the correction of a sentence, as shown in FIG. 2:
1. Sentence and Null-words Cleaning (blocks 40 and 42)
2. False positive (block 44)
3. Form error detection (Linkage analysis) (block 46)
4. Structure/complex error analysis (block 48)

Each of these modules is coupled to a correction options generator 50 having an associated word modifier 52 which uses databases and word-transformation rules to provide the replacement word in the form that fulfills the grammatical rule. Correction options are displayed for the user 54, who accepts those corrections he chooses.

It will be appreciated that these operations must be carried out in a specific order. This order is important because each operational layer helps the next layer to work better. Since some errors upset the sentence structure, it is important to understand, as well as possible, what the structure of the sentence is.

Sentence cleaning tries to recognize improbable combinations in the sentence. Thus, the cleaning phase (block 40) tries to correct several minor errors using EDE rules that don't need to examine the whole structure (i.e., sentence, phrase) but restrict their examination to the close environment of a given word. This is very useful to actually “clean” the sentence of small annoying errors, like incorrect use of homonyms (words that sound alike but have different spelling and different meanings). Since homonyms are generally different parts of speech, these errors can be corrected relatively easily. At least the most commonly interchanged homonyms preferably are corrected at this stage. Exemplary homonym errors are:

Its—it's error

Then—than error

To—too—two error

According to a preferred embodiment of the invention, each EDE cleaning rule looks for an anchor word in the sentence. Then, the rule checks the anchor's environment, typically the previous or following word, to determine if there is an error or there isn't. Specific exemplary rules for correcting these erroneous homonyms are set forth in Appendix II.

As can be seen from Appendix II, for the corrections to work, a correct sentence is not required. The EDE cleaning rules check the environment of the anchor, and act in consequence. These corrections are very important because they provide better sentence quality for the grammar correction module to work with. Thus, the more complete this portion of the checker is, the better the sentence cleaning module is able to clean the sentence and, thus, the EDE acts more efficiently when it comes to correcting the whole sentence.

Next, the text is examined by the null-word cleaner 42. A null-words error means that the parser was not able to reach any correct parsing for certain words, and removes that word or words. In this situation, the EDE looks to see if the removed words were essential. The check is simple: if the parser has accepted all but one word, and this word is either a preposition or a determiner, there is a fair chance that these words are either superfluous or not in the right place. Exemplary rules for correcting a null-words error, according to a preferred embodiment of the invention, are set forth in Appendix III.

It is important that all null-words errors be corrected, as the following EDE rules require complete parsing of the sentence, which means that the parser has taken into consideration in its parsing result every word in the sentence.

False Positive

The false positive test is used to avoid incorrect identification of errors by the parser. This is mainly useful in the case of form (linkage) errors. In certain situations, the parser may identify error links incorrectly, by attributing to it a wrong error. This module analyses each error link to ensure that it is correctly identified. A list of linkage errors is stored in the EDE and each identified error link is compared with the list, to determine that it does, indeed, fall within the correct category. The list includes a group of linkage error indications which are likely to be received from the parser but, which, in reality, are incorrectly identified. If the error link falls within the category of incorrectly identified errors, the module correctly identifies the error and creates an error object and erases the error link.

Once the text has been “cleaned” in the sentence cleaning, null words and false positive modules, the text undergoes linkage analysis (block 46). Linkage analysis recognizes the errors that were flagged by the logical parser. The logical parser can point out simple form errors very easily. The concept is very simple. During parsing, error links in the sentence were defined. As pointed out above, these links preferably have the same name or identification as the correct version of the link, but with an additional marker, e.g., at the end.

The EDE recognizes these error links in the parser result and receives from the corrections options generator at least one suggested correction which would cause the linkage to comply with the EDE rules (block 50), and displays the suggested correction or corrections to the user (block 54).

The user may now choose the correction option he prefers for correcting the sentence.

The final analysis (block 48) is structure and complex error analysis and correction, which are implemented by the EDE. This module checks the whole sentence and corrects complex structure errors, which are identified according to the EDE grammatical rules, in accordance with the parsing result. These are the most impressive corrections, because they actually clear the text and make it more readable. This analysis requires a complete parsing result because without it, the sentence would be damaged, since the parser was not able to parse the whole sentence. The rules applied to the sentences use the groups and phrases defined by the language management rules, to identify each part of the sentence and then act in consequence. Each definition is a formal logical grammatical rule. This means that in order to apply the rule, it is sufficient to translate the formal definition of the rule into computer language. Each of the language-management rules can be implemented as an algorithm in actual programming to recognize and correct an error. According to a preferred embodiment, the constituent tree of the sentence is also built by the parser. A constituent tree is the arborescence leading from a single word function, through a phrase, a clause and finally to a sentence. The constituent tree is the parsed version of the phrases, similar to that utilized by Link Grammar. An exemplary set of sentence error correction rules are set forth in Appendix IV.

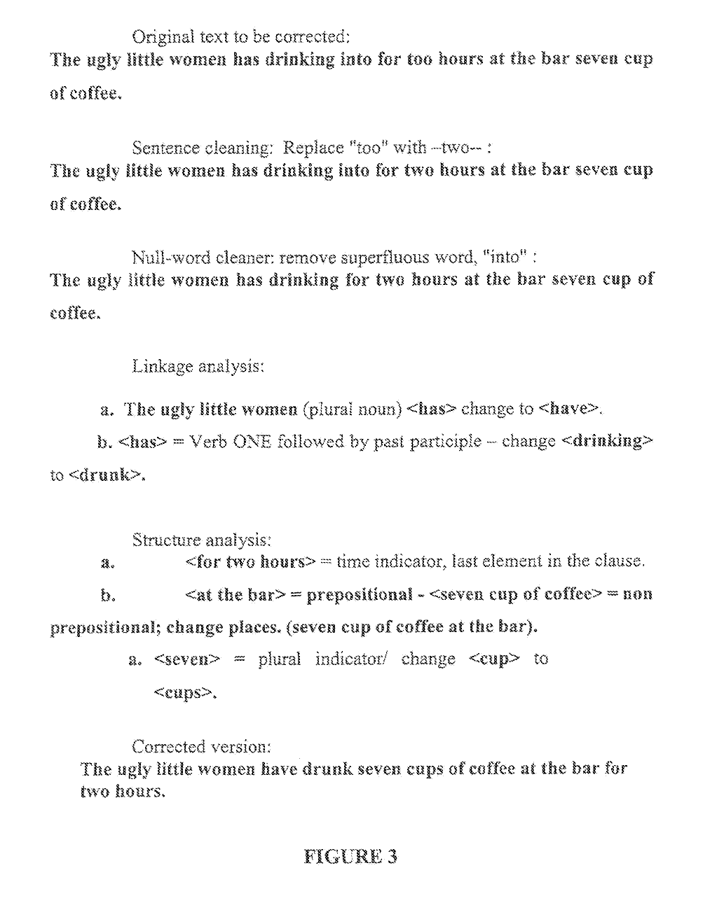

Referring now to FIG. 3, there is shown a textual example of the grammar checking process of a phrase of text, according to one embodiment of the invention.

According to a preferred embodiment of the invention, a spell checker and the logical parser are on a client while EDE is in a server to which the client is coupled, i.e., on the Internet, for access by all.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A method for parsing a computerized text, the method comprising:
preparing a set of logical rules, using logical grammatical links, for parsing a text;
using said logical rules to identify a part of speech of each word of text and all links between said words in said text; and
labeling said links as grammatically correct links or grammatically incorrect links for correction, so as to parse substantially every word in the text.

2. The system according to claim 1, wherein said step of identifying all links includes building a constituent tree.

3. A method for grammar checking of a computerized text, the method comprising:
preparing a collection of absolute grammatical rules defining substantially all possible text links;
applying said grammatical rules to parsed text for identifying grammatical errors in said text; and
providing at least one suggested correction which is grammatically correct according to said rules.

4. The method according to claim 3, further comprising:
preliminary sentence cleaning to remove errors in a close environment of a given word, before said step of applying.

5. The method according to claim 4, further comprising:
correcting null-words errors to remove unparsable words, after said step of sentence cleaning.

6. The method according to claim 5, further comprising false positive analysis to correct link errors incorrectly identified by said parser, after said step of correcting null-words errors.

7. The method according to claim 1, further comprising linkage analysis for analyzing links between pairs of words in the text and determining whether meet said grammatical rules.

8. The method according to claim 6, further comprising sentence structure analysis for analyzing structure of the text according to said grammatical rules.

9. The method according to claim 7, further comprising sentence structure analysis for analyzing structure of the text according to said grammatical rules.

10. A logical parser comprising:
a set of logical rules, using logical grammatical links, for parsing a text;
said logical rules including rules for identifying a part of speech of each word of text and all links between said words in said text, and labeling said links as grammatically correct links or grammatically incorrect links for correction, to parse completely said text.

11. A system for checking grammar of a computerized text, the system comprising:
a logical error identification module including:
a collection of absolute grammatical rules defining substantially all possible text links; and
an error-detection engine for applying said grammatical rules to parsed text for identifying grammatical errors and providing at least one suggested correction which is grammatically correct according to said rules.

12. The system according to claim 11, further comprising a parser for parsing substantially every word in said text and providing completely parsed text to said logical error correction module.

13. The system according to claim 11, further comprising a logical parser having a set of logical rules using logical grammatical links for parsing substantially every word in a text and providing completely parsed text to said logical error correction module.

14. The system according to claim 13, wherein
said logical rules include rules for identifying a part of speech of each word of text and all links between said words in said text, and labeling said links as grammatically correct links or grammatically incorrect links for correction, to parse completely said text; and
said grammatical rules include rules for identifying said labeled links.

15. The system according to claim 11, wherein said parser utilizes a constituent tree.

16. The system according to claim 11, wherein said error detection engine includes a sentence cleaning module.

17. The system according to claim 11, wherein said error detection engine includes a null words cleaner module.

18. The system according to claim 11, wherein said error detection engine includes a false positive correction module.

19. The system according to claim 11, wherein said error detection engine includes a linkage analysis module.

20. The system according to claim 11, wherein said error detection engine includes a structure analysis module.
